(19) United States
(12) Patent Application Publication
(10) Pub. No.: US 2013/0316553 A1
(43) Pub. Date: Nov. 28, 2013

(54) ELECTRIC CONNECTOR WITH PLUG MODULE

(71) Applicant: Te-Chi LEE, New Taipei City (TW)

(72) Inventor: Te-Chi LEE, New Taipei City (TW)

(73) Assignee: TECX-UNIONS TECHNOLOGY CORP.

(21) Appl. No.: 13/481,774

(22) Filed: May 25, 2012

(51) Int. Cl. H01R 13/44

(52) U.S. Cl. 439/131

(57) ABSTRACT

An electric connector includes an insulating base and a plug module, and a positioning spring plate is extended from the insulating base, and the insulating base and the positioning spring plate are integrally formed. The plug module comprises a rotating shaft and a pair of conductive pins fixed to the rotating shaft, and the rotating shaft includes a polygonal block, and the rotating shaft is pivotally coupled to the insulating base, and the polygonal block and the positioning spring plate are installed corresponding to each other and abutted and positioned with a multiple of stages, such that the electric connector can have the advantages of simplified components, a low cost and a stable structure.

### FIELD OF THE INVENTION

The present invention relates to an electric connector, in particular to the electric connector with a plug module.

### BACKGROUND OF THE INVENTION

In general, electric appliances come with a connector, and the connector has a plug for connecting an external power and allowing the power to pass through an internal circuit to serve as an adapter or a charger, and the power is rectified and then provided for charging the electric appliances directly or a battery of the electric appliances. However, the plug is comprised of two metal plates, and the tips of the two metal plates protruding from the plug may be touched accidentally. In addition, the present electric appliances are designed with the features of convenient portability and simple appearance, so that most plugs of the connectors are foldable into a casing of the connectors.

With reference to FIGS. 1 to 3 for a conventional connector with a foldable plug, the connector comprises a main body 10 and a conductive plug 20, and the main body 10 has a containing slot 101; the conductive plug 20 is pivotally coupled to the main body 10 and can be rotated and stored into the containing slot 101, such that the conductive plug 20 can be protruded out from the main body 10 or the conductive plug 20 can be received into the containing slot 101. When the connector is not in use, the conductive plug 20 can be folded and contained in the main body 10 to avoid the contact with the tip of the plug while maintaining the aesthetic appearance of the connector.

However, a snap block 201 is generally formed at an end of the conductive plug 20 of the connector with a foldable plug, and then a positioning element 30 is installed in the main body 10, wherein the positioning element 30 has a positioning slot 301 in a shape corresponding to the shape of the snap block 201, so that the snap block 201 can be passed and snapped into the positioning slot 301 with a multiple of stages to achieve the effect of positioning the conductive plug 20, so as to prevent the conductive plug 20 from being folded incompletely or conducted incompletely. In such arrangement, the positioning element 30 requires an accessory in order to be fixed onto the main body 10, and the required manufacturing precision of the positioning slot 301 and the snap block 201 is very high, thus resulting in a use of more components and incurring a higher cost. In addition, the positioning slot 301 and the snap block 201 may be worn out easily after a long time of use.

In view of the foregoing problems, the inventor of the present invention conducted extensive researches and experiments, and finally provided a feasible design to overcome the problems.

### SUMMARY OF THE INVENTION

Therefore, it is a primary objective of the present invention to provide an electric connector with a plug module comprising an insulating base, and a positioning spring plate integrally formed with the insulating base, wherein the plug module comprises a polygonal block and a positioning spring plate abutted and coupled with each other, such that a conductive pin can be positioned at a multiple of stages. Therefore, the electric connector of the present invention has the advantages of simplified components, a low cost and a stable structure.

To achieve the aforementioned objective, the present invention provides an electric connector, comprising: an insulating base, having a positioning spring plate extended from the insulating base and integrally formed with the insulating base; and a plug module, including a rotating shaft and a pair of conductive pins fixed to the rotating shaft, and the rotating shaft having a polygonal block and being pivotally coupled to the insulating base, and the polygonal block and the positioning spring plate being coupled and positioned at a plurality of stages with one another.

The present invention further has the following effects.

(1) The insulating base includes the positioning spring plate integrally formed with the insulating base, and the plug module includes the polygonal block and the positioning spring plate abutted and coupled with each other, and the external shape of the polygonal block and the elasticity of the positioning spring plate are used to push the polygonal block to selectively switch from contacting or not contacting the positioning spring plate, such that the conductive pin can be set to two rotating positions for ON and OFF states respectively. In the meantime, the positioning spring plate will produce a short sound of snapping the polygonal block when the conductive pin is set to an ON or OFF state to let users know about the positioning and prevent the conductive pin from being folded or conducted incompletely.

(2) The positioning spring plate and the insulating base of the present invention are integrally formed with each other, so that the electric connector of the present invention has the advantages of simplified components and a low cost.

(3) The present invention simply installs the polygonal block and the positioning spring plate adjacent to each other, and uses the external appearance of the polygonal block and the elasticity of the positioning spring plate to push the polygonal block to selectively switch contacting or not contacting with the positioning spring plate, so that there will be no concentrated stress or worn-out issues of components in a long time of use, and the electric connector of the present invention can provide a stable structure.

(4) The invention includes two positioning spring plates, or the electric connector of the present invention further includes an elastic arm installed on both sides of the polygonal block separately to improve the effect of adjusting the positions of the polygonal block and the positioning spring plate.

### BRIEF DESCRIPTION OF THE DRAWINGS

FIG. 1 is a perspective view of a conventional connector with a foldable plug;

FIG. 2 is an exploded view of a conventional connector with a foldable plug;

FIG. 3 is another perspective view of a conventional connector with a foldable plug;

FIG. 4 is an exploded view of an electric connector of the present invention;

FIG. 5 is a perspective view of an electric connector of the present invention;

FIG. 6 is a cross-sectional view of an electric connector of the present invention;

FIG. 7 is another cross-sectional view of an electric connector of the present invention;

FIG. 8 is a further cross-sectional view of an electric connector of the present invention;

FIG. 9 is a schematic view of an application of an electric connector of the present invention;

FIG. 10 is a schematic view of another application of an electric connector of the present invention;

FIG. 11 is a schematic view of a further application of an electric connector of the present invention;

FIG. 12 is a cross-sectional view of an electric connector in accordance with another preferred embodiment of the present invention; and

FIG. 13 is a cross-sectional view of an electric connector in accordance with a further preferred embodiment of the present invention.

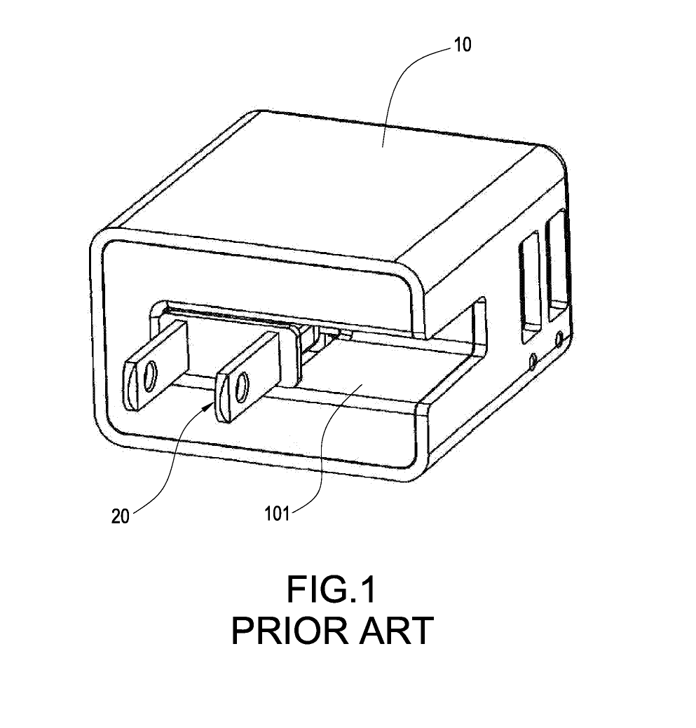

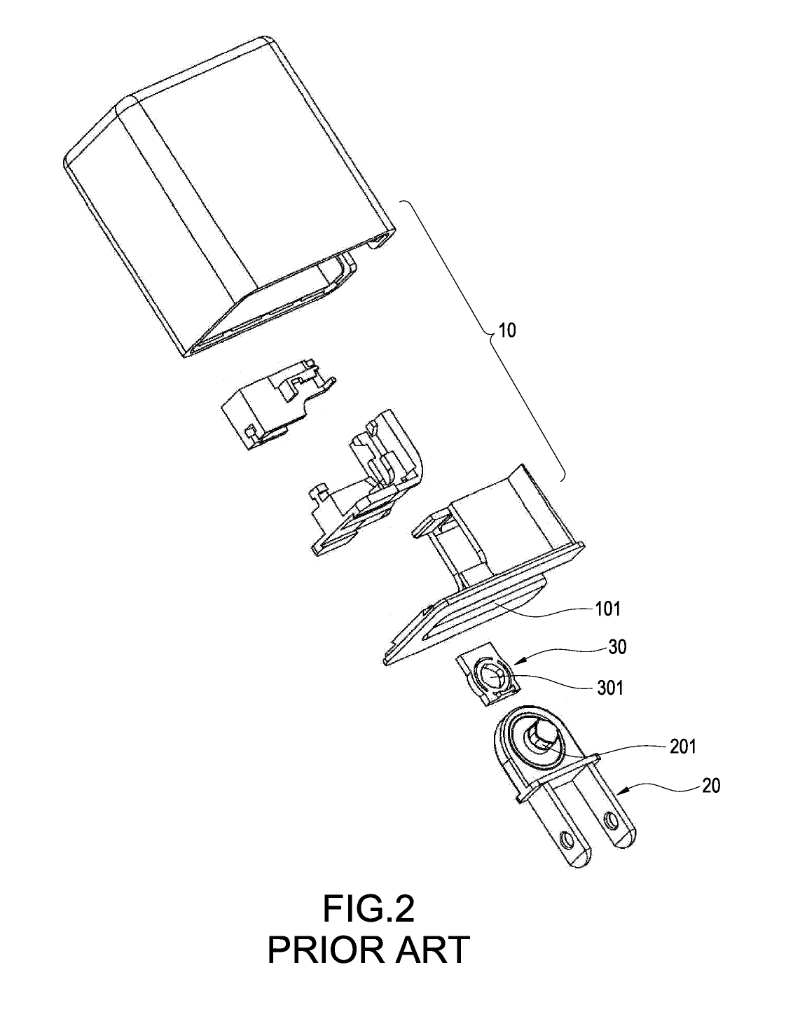

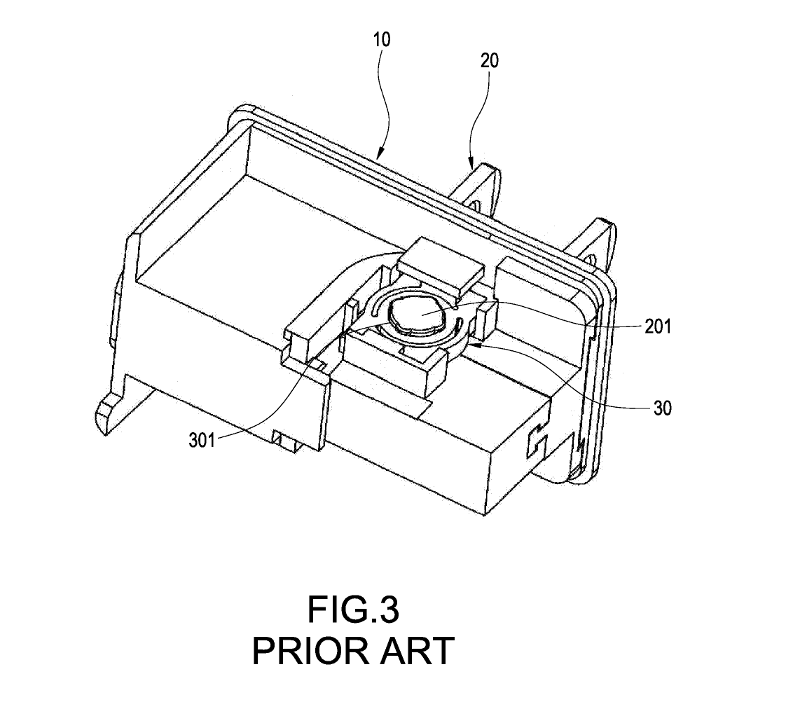

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

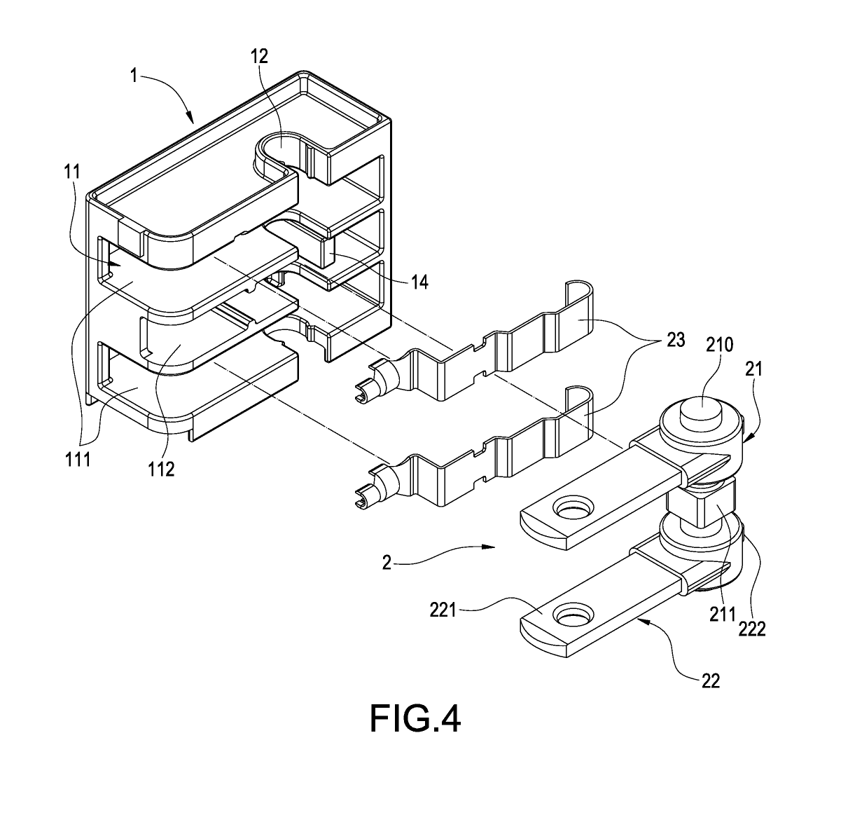

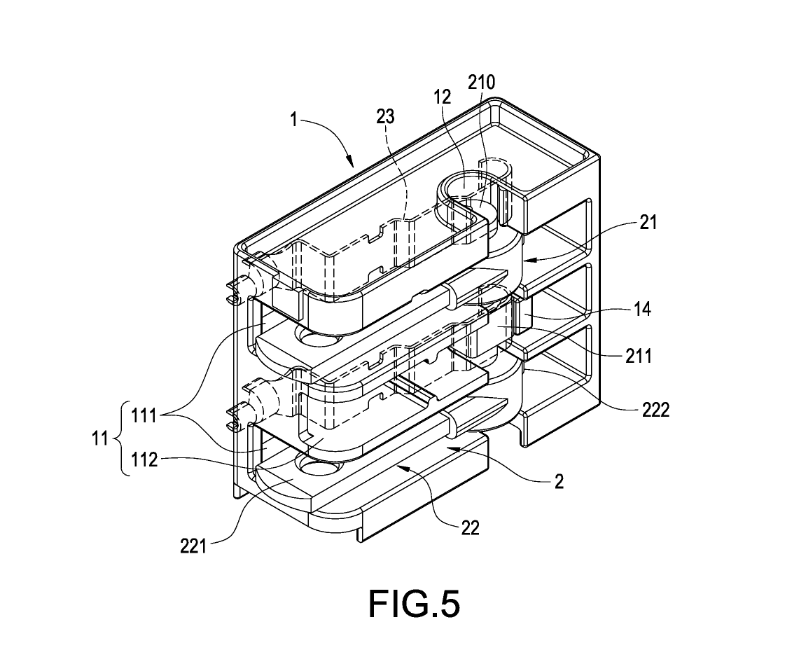

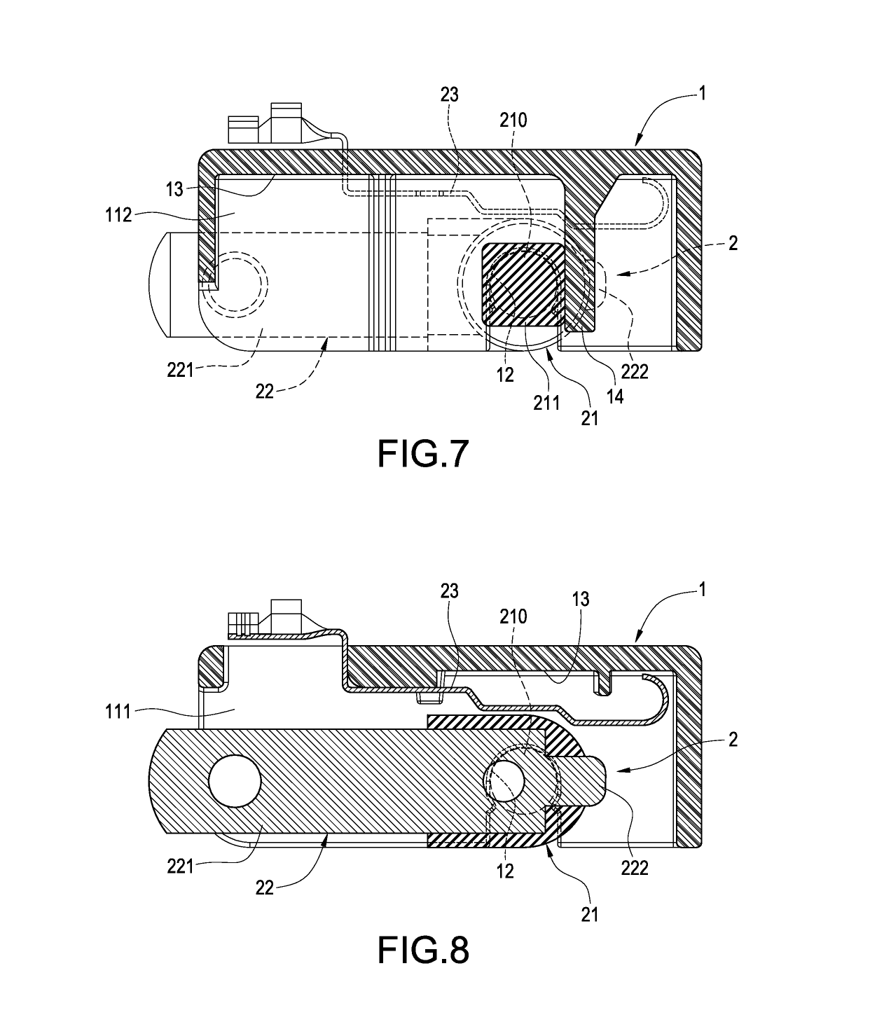

With reference to FIGS. 4 to 11 for an electric connector with a plug module of the present invention, the electric connector 100 comprises an insulating base 1 and a plug module 2.

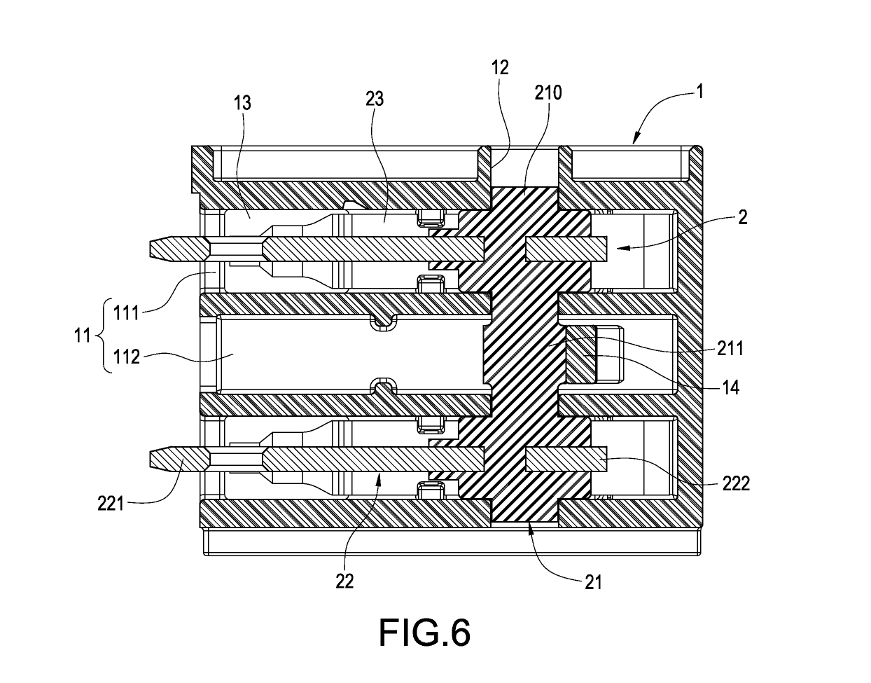

The insulating base 1 has a containing slot 11 and a hinge hole 12 formed on both sides of the containing slot 11 separately, and the containing slot 11 has an internal wall 13, and a positioning spring plate 14 is protruded from the internal wall 13 and integrally formed with the insulating base 1, wherein the internal wall 13 can be a bottom wall or a side wall as shown in FIG. 6, and the positioning spring plate 14 is extended from the bottom wall or extended from the side wall depending on actual requirements. In addition, the containing slot 11 includes a first containing slot 111 and a second containing slot 112 disposed between the first containing slots 111, and the design of the containing slot 11 is not limited to this preferred embodiment only, but can be adjusted according to the actual requirements, and the positioning spring plate 14 is installed in the second containing slot 112.

The plug module 2 comprises a rotating shaft 21, a pair of conductive pins 22 and a pair of conductive terminals 23, and the rotating shaft 21 is pivotally coupled to the insulating base 1, and the pair of conductive pins 22 are fixed to the rotating shaft 21, so that the pair of conductive pins 22 are contained and rotated in the containing slot 11, and the pair of conductive terminals 23 are installed in the containing slot 11, wherein the rotating shaft 21 includes a hinge portion 210 formed on both sides of the rotating shaft 21 and a polygonal block 211 formed at the middle of the rotating shaft 21, and each hinge portion 210 is pivotally coupled to each corresponding hinge hole 12, and the polygonal block 211 and the positioning spring plate 14 are installed corresponding to each other, so that the polygonal block 211 can be abutted and positioned by a multiple of stages through the positioning spring plate 14. In addition, each conductive pin 22 has an insert section 221 at an end and a conducting protrusion 222 at the other end, and the conducting protrusion 222 is abutted and coupled to the conductive terminal 23. In addition, the containing slot 11 includes a first containing slot 111 and a second containing slot 112, and the pair of conductive pins 22 and the pair of conductive terminals 23 are installed in the first containing slot 111. The polygonal block 211 can be a polygonal cylinder such as a triangular cylinder, a rectangular cylinder or a pentagonal cylinder.

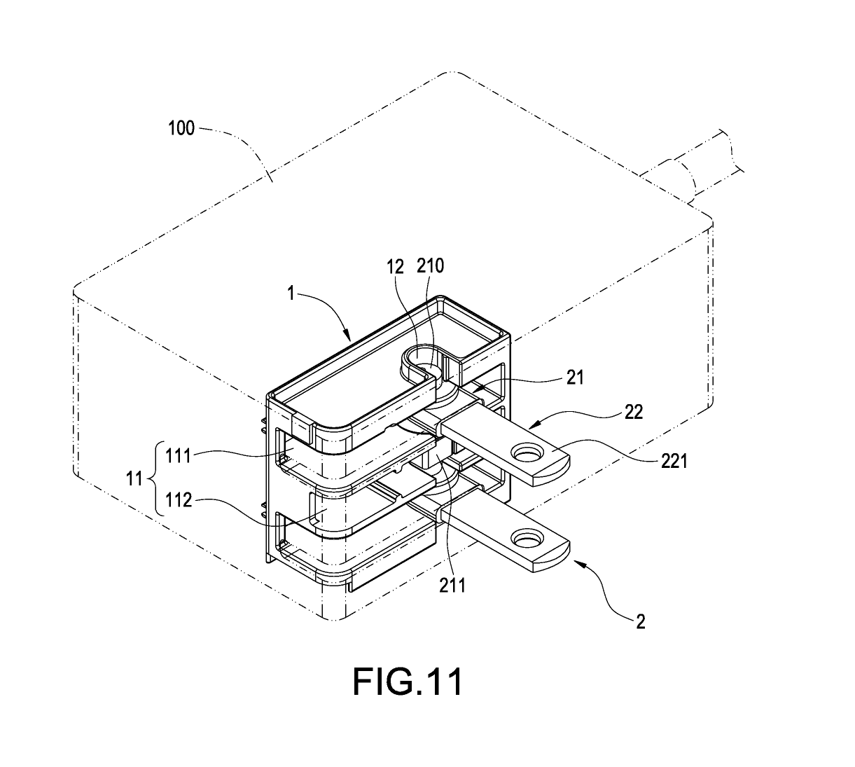

In FIG. 11, the assembly of the electric connector with a plug module of the present invention includes the positioning spring plate 14 extended from the insulating base 1 and integrally formed with the insulating base 1. The plug module 2 includes the rotating shaft 21 and the pair of conductive pins 22 fixed to the rotating shaft 21, and the rotating shaft 21 includes a polygonal block 211, and the rotating shaft 21 is pivotally coupled to the insulating base 1, and the polygonal block 211 and the positioning spring plate 14 are installed corresponding to each other and abutted and positioned at a multiple of stages.

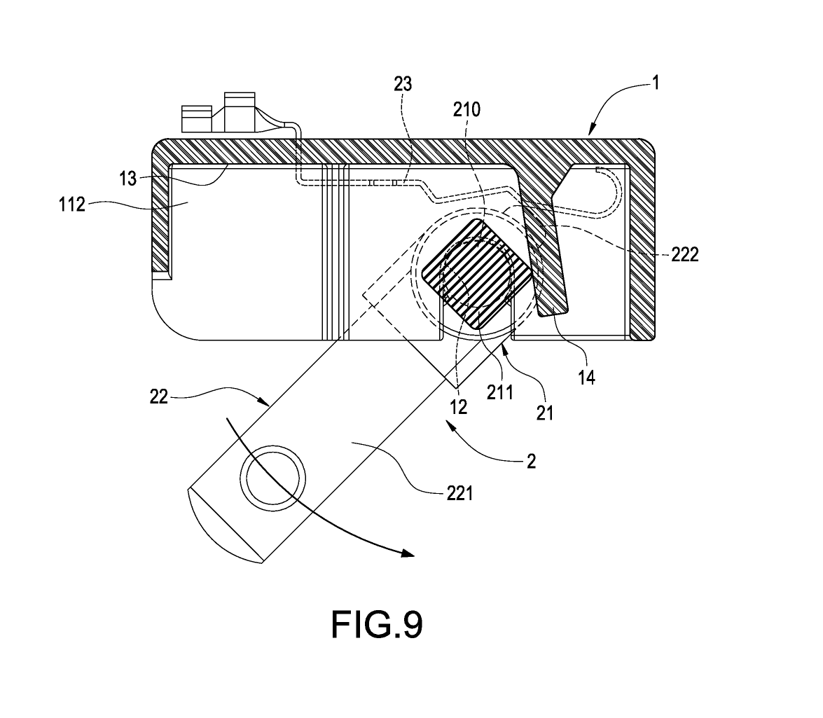

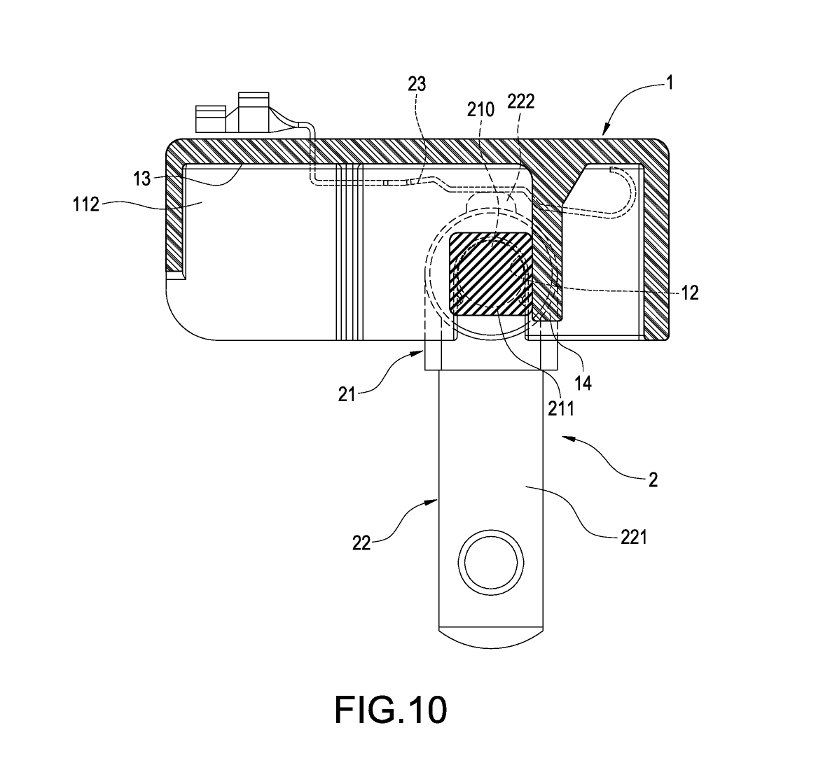

With reference to FIGS. 9 and 10 for schematic views of the applications of the electric connector of the present invention respectively, when the conductive pins 22 are turned, the external appearance of the polygonal block 211 has a plurality of planes and a plurality of coupling angles, so that the coupling angles of the polygonal block 211 will be contacted with the positioning spring plate 14 to provide a pushing force to elastically deform the positioning spring plate 14 sideway. In meantime, when the force exerted onto the polygonal block 211 by the positioning spring plate 14 disappears, the positioning spring plate 14 will produce a restoring force to drive the polygonal block 211 to turn to a plane, so that the polygonal block 211 can be switched to selectively contact or not to contact the positioning spring plate 14. Therefore, the polygonal block 211 and the positioning spring plate 14 can be adjusted and positioned at a multiple of stages.

Since the polygonal block 21 and the positioning spring plate 14 are disposed adjacent to each other, and the external appearance of the polygonal block 21 and the elasticity of the positioning spring plate 14 are used to push the polygonal block 211 to selectively switch to contact or not to contact the positioning spring plate 14 to let the conductive pin 22 to be set at two rotating positions for an ON state (when the insert section 221 is protruded from the insulating base 1) and an OFF state (when the insert section 221 is embedded into the insulating base 1). In the meantime, when the conductive pin 22 is situated at the ON or OFF state, a short sound is produced when the positioning spring plate 14 snaps the polygonal block 211 to let users determine the positioning, so as to prevent the conductive pin 22 from being folded or conducted incompletely.

Compared with the prior art, the positioning spring plate 14 and the insulating base 1 of the present invention are integrally formed, so that the electric connector 100 of the present invention can have the advantages of simplified components and a low cost.

In addition, most conventional electric connectors use the snap block and the positioning slot to achieve the multi-stage snapping effect, and thus concentrated stress may be produced between the components easily, and the components will be worn out easily after a long time of use. On the other hand, the present invention simply installs the polygonal block 21 and the positioning spring plate 14 adjacent to each other, and the external appearance of the polygonal block 21 and the elasticity of the positioning spring plate 14 are used to push the polygonal block 211 to switch to contact or not to contact the positioning spring plate 14 selectively, so that there is no concentrated stress or worn-out issue even after a long time of use. Obviously, the electric connector 100 of the present invention has a stable structure.

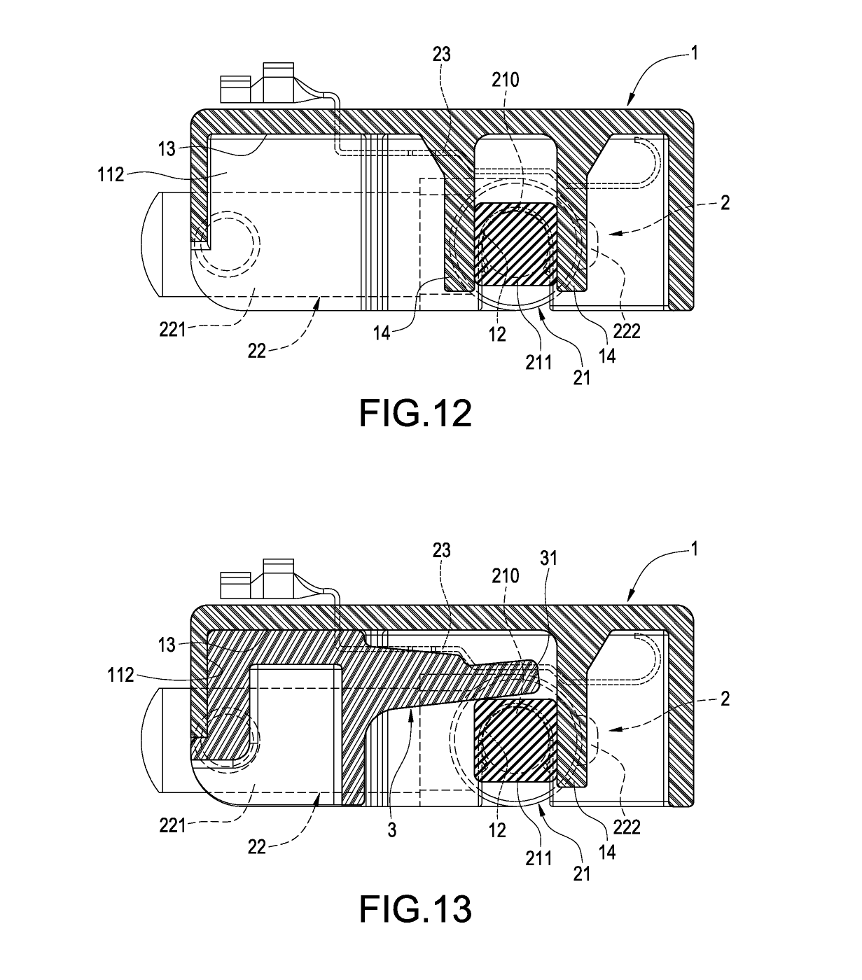

With reference to FIG. 12 for an electric connector in accordance with another preferred embodiment of the present invention, two positioning spring plates 14 are adopted in this preferred embodiment and are installed on both sides of the polygonal block 211 respectively, and the polygonal block 211 of this preferred embodiment is a rectangular body, and the two positioning spring plates 14 are installed on opposite sides of the rectangular body respectively. Therefore, the adjustment of the positions of the polygonal block 211 and the positioning spring plate 14 can be enhanced.

With reference to FIG. 13 for an electric connector in accordance with a further preferred embodiment of the present invention, the electric connector 100 further comprises an elastic arm 3 installed in the containing slot 11, and the elastic arm 3 includes a positioning portion 31, wherein the positioning portion 31 and the positioning spring plate 14 are disposed on both sides of the polygonal block 211 respectively. In this preferred embodiment, the polygonal block 211 is a rectangular body, and the positioning spring plate 14 and the positioning portion 31 are disposed on opposite sides of the rectangular body. Therefore, the effect of adjusting the positions of the polygonal block 211 and the positioning spring plate 14 can be improved.

In summation of the description above, the present invention overcomes the drawbacks of the prior art and complies with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. An electric connector, comprising:
an insulating base, having a positioning spring plate integrally formed with the insulating base; and
a plug module, including a rotating shaft and a pair of conductive pins fixed to the rotating shaft, and the rotating shaft having a polygonal block and being pivotally coupled to the insulating base, and the polygonal block and the positioning spring plate being coupled and positioned at a plurality of stages with one another.

2. The electric connector as recited in claim 1, wherein the insulating base has a containing slot for containing and rotating the pair of conductive pins in the containing slot, and the containing slot has an internal wall having the positioning spring plate protruded from the internal wall.

3. The electric connector as recited in claim 2, wherein the internal wall is a bottom wall or a side wall.

4. The electric connector as recited in claim 2, wherein the plug module includes a pair of conductive terminals installed in the containing slot, and each of the conductive pins has an insert section at one and the conducting protrusion at the other end, and the conducting protrusion abuts and connects the conductive terminal.

5. The electric connector as recited in claim 4, wherein the containing slot includes a first containing slot and a second containing slot disposed between the first containing slot, and the pair of conductive pins and the pair of conductive terminals are installed in the first containing slot, and the positioning spring plate is installed in the second containing slot.

6. The electric connector as recited in claim 2, wherein the positioning spring plate comes with a quantity of two, and the two positioning spring plates are installed on both sides of the polygonal block respectively.

7. The electric connector as recited in claim 6, wherein the polygonal block is a rectangular body, and the two positioning spring plates are installed on adjacent sides or opposite sides of the rectangular body respectively.

8. The electric connector as recited in claim 2, further comprising an elastic arm installed in the containing slot and having a positioning portion, and the positioning portion and the positioning spring plate being installed on both sides of the polygonal block respectively.

9. The electric connector as recited in claim 8, wherein the polygonal block is a rectangular body, and the positioning spring plate and the positioning portion are disposed on adjacent sides or opposite sides of the rectangular body respectively.

10. The electric connector as recited in claim 2, wherein the insulating base has a hinge hole formed on opposite sides of the containing slot separately, and a hinge portion formed on both sides of the rotating shaft separately, and each hinge portion is pivotally coupled to each corresponding hinge hole.
